(19) United States
(12) Patent Application Publication
(10) Pub. No.: US 2008/0019797 A1
(43) Pub. Date: Jan. 24, 2008

(54) FASTENER WITH EMBEDDED GUIDE HOLE

(76) Inventors: Duane Carlson, Kilaue, HI (US); Michael C. Milo, Knox, IN (US)

Correspondence Address: BLACK LOWE & GRAHAM, PLLC, 701 FIFTH AVENUE, SUITE 4800, SEATTLE, WA, 98104, US

(21) Appl. No.: 11/459,282

(22) Filed: Jul. 21, 2006

(51) Int. Cl. F16B 33/00

(52) U.S. Cl. 411/403; 411/378

(57) ABSTRACT

A fastener includes a threaded shaft and a grippable head secured to the threaded shaft. An aperture extends through the shaft toward the head. The aperture extends partially through the head. In some embodiments, the shaft includes both threaded and unthreaded portions. In such embodiments, the aperture may extend slightly past the threaded portion into the unthreaded portion, such that it spans the point of stress concentration between the threaded and unthreaded portions. In yet another embodiment, a threaded fastener having a head and a threaded shaft has an aperture extending through the head and partially through the threaded shaft. The aperture has a diameter substantially equal to a width of a recess sized to receive a wrench. The aperture may have a shape such that it can also be gripped by a wrench.

### FIELD OF THE INVENTION

This invention relates generally to fasteners and, more specifically, to systems and methods for removing damaged fasteners.

### BACKGROUND OF THE INVENTION

It is not uncommon for a bolt, stud, or other fastener to become broken to the extent that it cannot be removed by conventional tools. Bolt heads may become rounded or break off completely, leaving the remnant of the stud or bolt. Typically, the fastener is removed by first drilling a hole in the center of the fastener then driving in a thin rod with a square, rectangular, diamond, or other multi faceted cross-section. An exposed end of the thin rod is then gripped with a tool such as a specialized wrench or drill chuck and the fastener is threaded out of its aperture. In other systems, reverse direction threads are formed in the drilled hole in order to receive a reverse threaded tool that is twisted to unthread the broken bolt.

Drilling a hole to receive the thin rod is an extremely risky operation. The hole usually must extend a substantial distance into the fastener in order to provide a sufficient gripping length for the thin rod. If the drill bit is off-center or angled with respect to the central axis of the fastener, it is not uncommon for the drill bit to remove material from the structure to which the fastener secures. In sensitive applications, such as aircraft and precision machinery, this is unacceptable and can require scrapping of large and expensive parts.

In view of the foregoing it would be an advancement in the art to provide a fastener enabling removal according to the foregoing method while reducing the risk of damage to structures to which the fastener secures.

### SUMMARY OF THE INVENTION

A fastener includes a threaded shaft and a grippable head secured to the threaded shaft. An aperture extends through the shaft toward the head. The aperture may extend partially through the head. In some embodiments, the shaft includes both threaded and unthreaded portions. In such embodiments, the aperture may extend slightly past the threaded portion into the unthreaded portion, such that it spans the point of stress concentration between the threaded and unthreaded portions.

In a similar embodiment, a threaded stud includes threaded end portions and a central unthreaded portion. Guide apertures extend through the threaded portions and slightly into the unthreaded portion such that the apertures span the transition between threaded and unthreaded portions. The apertures do not meet, such that there is a web of material between the apertures.

In yet another embodiment, a threaded fastener having a head and a threaded shaft has an aperture extending through the head and partially through the threaded shaft. The aperture has a diameter substantially equal to a width of a recess sized to receive a wrench. The aperture may have a shape such that it can also be gripped by a wrench.

### BRIEF DESCRIPTION OF THE DRAWINGS

Preferred and alternative embodiments of the present invention are described in detail below with reference to the following drawings.

FIG. 1 is a perspective view of an embodiment of a fastener secured to a structure having the head of the fastener removed in accordance with an embodiment of the invention;

FIG. 2 is a side cross-sectional view of an embodiment of a fastener secured to a structure in accordance with an embodiment of the invention;

FIG. 3 is a side cross-sectional view of an embodiment of a fastener secured to a structure in accordance with an embodiment of the invention;

FIG. 4 is a side cross sectional view of an embodiment of a fastener secured to a structure in accordance with an embodiment of the invention;

FIG. 5 is a side view of a stud formed in accordance with an embodiment of the invention;

FIG. 6 is a side cross-sectional view of an embodiment of a fastener in accordance with an embodiment of the invention;

FIG. 7 is a side cross-sectional view of an embodiment of a fastener in accordance with an embodiment of the invention;

FIG. 8 is an end view of the fastener of FIG. 7;

FIG. 9 is a side cross-sectional view of an embodiment of a fastener in accordance with an embodiment of the invention; and

FIG. 10 is a top cross-sectional view of an embodiment of a fastener in accordance with an embodiment of the invention.

### DETAILED DESCRIPTION OF THE PREFERRED EMBODIMENT

Referring to FIG. 1, a fastener 10, such as a bolt 10, typically passes through an aperture 12 formed in a workpiece 14 to fasten the workpiece 14 to another object. If the head 16 breaks away, such as during tightening or loosening of the fastener 10 by a wrench T, the threaded shaft 18 of the fastener 10 remains in the workpiece 14 or underlying object. In a preferred embodiment of the invention, breaking off the head 16 exposes a guide hole 38 extending through a portion of the threaded shaft 18.

The guide hole 38 is used to remove the threaded shaft 18 by drilling a concentric hole slightly larger than the guide hole 38. The drill typically rotates in a clockwise direction while drilling for fasteners with right-handed threads. The direction of the drill is then reversed to remove the threaded shaft 18. In other methods, left-handed threads are formed in the guide hole 38 and a left-hand threaded tool is inserted in the hole 38 and turned to remove the threaded shaft 18. In still other embodiments, a thin rod with square, diamond, hexagonal, or other faceted cross-section, is driven into the hole and then turned to remove the threaded shaft 18.

Inasmuch as the guide hole 38 does not extend completely through the fastener 10, the fastener 10 may still serve as a seal. The guide hole 38 in some applications will also serve to strengthen the fastener 10 inasmuch as the innermost material of the fastener will be exposed to any heat treatment applied to the fastener 10.

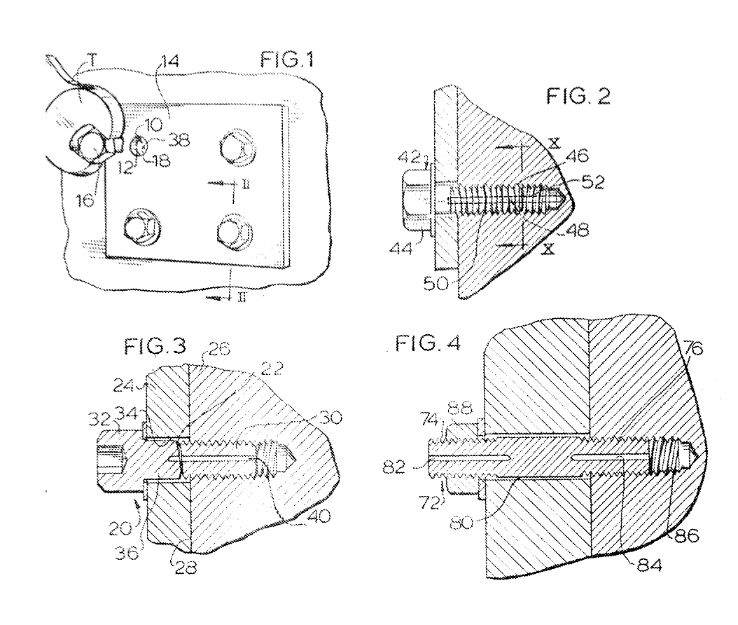

Referring to FIG. 2, in some embodiments a fastener 42 having a head 44 is secured within a threaded aperture 46 by a shaft 50 bearing threads 52. A guide hole 48 extends from the end of the bolt toward the head 44 and extends partially into the head 44. In this manner, the guide hole 48 will have a good likelihood of being exposed if the head 44 or a portion of the head 44 breaks off. In the embodiment of FIG. 2, the guide hole 48 extends within 1 to 2 mm of the top of the head 44. In other embodiments, the guide hole 48 extends through between 10% and 50% of the height of the head 44. In other embodiments, the guide hole 48 extends between 20% and 40% of the height of the head 44. In still other embodiments, the guide hole 48 extends only slightly past the boundary between the shaft 50 and the head 44. For example, the guide hole 48 may extend into the head 44 a distance equal to between 0.5% and 3% of the height of the head. In other embodiments, the guide hole 48 extends into the head 44 a distance equal to from 1 to 3 times the distance between the threads 52.

Referring to FIG. 3, in an alternative embodiment, a fastener 20 secures a first workpiece 24 to a second workpiece 26. The fastener 20 includes an unthreaded portion 36 corresponding to an unthreaded aperture 34 in the workpiece 24. The unthreaded portion is typically located near the head 32. The fastener 20 includes a threaded portion 30 below the unthreaded portion 36. In some applications, the unthreaded portion 36 is located near a boundary 28 between the first and second workpieces 24, 26 when the fastener 20 is in a secured position. In the embodiment of FIG. 3, a guide hole 40 extends from the end of the bolt and just past a boundary 22 between the unthreaded and threaded portions 36, 30. In some embodiments, the amount the guide hole 40 extends into the unthreaded portion 36 is between about 1 and 3 times the distance between threads formed on the threaded portion 30. In other embodiments, the guide hole 40 extends into the unthreaded portion 36 by an amount equal to about between 0.5% and 6% of the length of the unthreaded portion 36. In an alternative embodiment, the guide hole 40 extends into the unthreaded portion 36 a distance about equal to between 2% and 5% of the length of the unthreaded portion 36. This configuration of the guide hole 40 positions the guide hole 40 to be accessible if the head 32 and unthreaded portions 36 break away. Inasmuch as some stress concentration occurs at the boundary between the threaded and unthreaded portions 30, 36, this is a probable breaking point. This guide hole configuration further facilitates the use of fasteners 20 having an allen, torx, or other hole type formed in the head 32 such that the guide hole 40 cannot extend substantially through the head 32 without extending entirely through the fastener 20.

Referring to FIG. 4, in another embodiment a fastener 72 is embodied as a stud including an upper threaded portion 74, a central unthreaded portion 80, and a lower threaded portion 76. The lower threaded portion 76 is threaded into an aperture 86. The upper threaded portion 74 engages a nut 88. In the embodiment of FIG. 4, guide holes 82 and 84 extend through upper and lower ends of the fastener 72 without meeting, such that a web of material remains between the guide holes 82, 84. The guide holes 82 and 84 both extend slightly into the unthreaded portion 80. In one embodiment, the guide holes 82, 84 extend into the unthreaded portion 80 an amount equal to between 0.5% and 6% of the length of the unthreaded portion 80. In an alternative embodiment, the guide holes 82, 84 extend into the unthreaded portion 80 an amount equal to between 3% and 5% of the length of the unthreaded portion 80. In some embodiments, the amount the guide holes 82, 84 extend into the unthreaded portion 80 is between about 1 and 3 times the distance between threads formed on the threaded portions 74, 76. Extension of the guide holes 82, 84 into the unthreaded portion 80 ensures that the guide holes 82, 84 will be accessible if the fastener 72 breaks at stress concentration points at the boundaries between the threaded portions 74, 76 and the unthreaded portion 80.

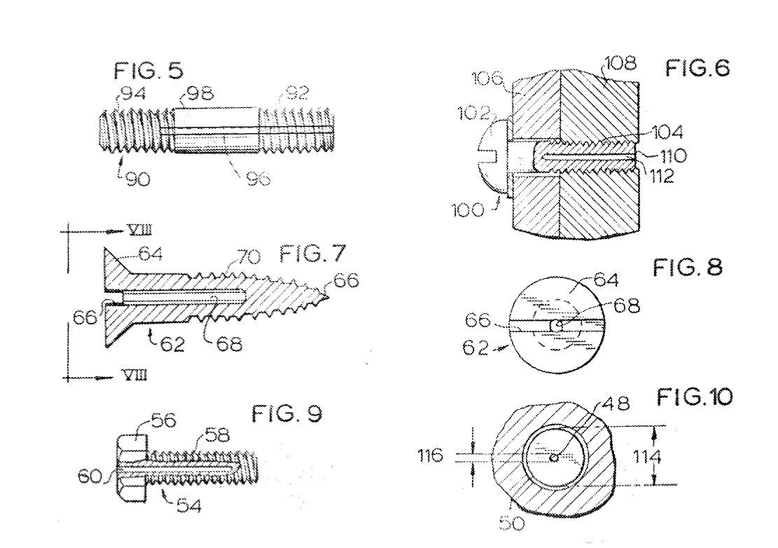

Referring to FIG. 5, in another embodiment of the invention, a fastener 90 includes first and second threaded portions 92, 94 on either side of an expandable sleeve 98. A guide hole 96 extends through one of the threaded portions 92 and the expandable sleeve and partially into the other of the threaded portions 94. As in the embodiment of FIG. 4 the extent of the guide hole 96 ensures that the guide hole 96 will be accessible if the fastener 90 breaks at stress concentration points at the boundary between the threaded portions 92, 94 and the sleeve 98. In one embodiment, the guide hole 96 extends into the threaded portion 94 an amount equal to between 0.5% and 6% of the length of the sleeve 98. In an alternative embodiment, the guide hole 96 extends into the threaded portion 94 an amount equal to between 3% and 5% of the length of the sleeve 98. In some embodiments, the amount the guide hole 96 extends into sleeve 98 is between about 1 and 3 times the distance between threads formed on the threaded portions 92, 94.

Referring to FIG. 6, in another embodiment of the present invention, a fastener 100 includes a head 102 for use with a slot screwdriver. The fastener 100 is used to join one or more workpieces 106, 108 by threading the fastener 100 into a threaded aperture 104 formed in the workpiece 108. A guide hole 112 extends from the lower end of a threaded portion 110 toward the head 102. The guide hole 112 may extend up to the head 102 or just past a boundary between threaded and unthreaded portions of the shaft 110. In one embodiment, the guide hole 112 extends into the unthreaded portion an amount equal to between 0.5% and 6% of the length of the unthreaded portion. In an alternative embodiment, the guide hole 112 extends into the unthreaded portion an amount equal to between 3% and 5% of the length of the unthreaded portion. In some embodiments, the amount the guide hole 112 extends into the unthreaded portion is between about 1 and 3 times the distance between threads formed on the threaded portions.

Referring to FIGS. 7 and 8, in another embodiment, a fastener 62 includes a head 64 suitable for receiving a screwdriver, including a slot at one end 66. A guide hole 68 extends from the head 64 toward the end of the fastener 62. The guide hole 68 typically does not extend completely through the fastener 62. In some embodiments, the guide hole 68 is hexagonal such that it may receive an allen wrench. In other embodiments, the guide hole 68 has some other faceted configuration to receive a wrench having a different shape such as a torx or triangular head. The diameter of the guide hole may be the same, or substantially the same, as the width of the slot 66.

Referring to FIG. 9 in another embodiment of the invention, a fastener 54 has a hexagonal head 56 and a threaded shaft 58. A guide hole 60 extends through head 56 rather than the bottom of the fastener 54. The guide hole 60 typically does not extend completely through the fastener 54.

Referring to FIG. 10, guide holes formed in accordance with the invention typically have a diameter 116 substantially less than the diameter 114 of the fastener. For example, in one embodiment, the diameter 116 is equal or less than 15% of the diameter 114. In another embodiment, the diameter 116 is equal or less than 10% of the diameter 114. In still other embodiments, the diameter 116 is equal or less than 5% of the diameter 114.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A fastener comprising:
a head comprising a grippable structure;
a threaded shaft having distal and proximal ends, the threaded shaft securing to the head proximate the proximal end thereof; and
wherein the threaded shaft includes an aperture extending from the distal end toward and partially through the head.

2. The fastener of claim 1, wherein the grippable structure is a recess sized to receive at least one of a phillips, slot, allen, or torx head.

3. The fastener of claim 1, wherein the grippable portion is a hexagonal bolt head.

4. The fastener of claim 1, wherein the aperture is a first aperture, the fastener further comprising a second aperture extending through the head, the first and second aperture being separated by a web of material integral to at least one of the head and threaded shaft.

5. The fastener of claim 4, wherein the first and second apertures are coaxial.

6. The fastener of claim 1, wherein the head further comprises an unthreaded shaft extending from the grippable portion, the unthreaded shaft secured to the proximal end of the threaded shaft, the aperture extending through the entire threaded shaft.

7. The fastener of claim 6, wherein the aperture extends partially through the unthreaded shaft.

8. The fastener of claim 1, wherein the aperture has a diameter substantially less than a diameter of the threaded shaft.

9. The fastener of claim 8, wherein the diameter of the aperture is less than 15% of the diameter of the threaded shaft.

10. The fastener of claim 9, wherein the diameter of the aperture is less than 10% of the diameter of the threaded shaft.

11. The fastener of claim 10, wherein the diameter of the aperture is less than 5% of the diameter of the threaded shaft.

12. A fastener comprising:
a head comprising a grippable structure;
a threaded shaft having distal and proximal ends, the threaded shaft securing to the head proximate the proximal end thereof; and
wherein the threaded shaft and head include an aperture extending through the head and partially through the threaded shaft.

13. The fastener of claim 12, wherein the diameter of the aperture is less than 15% of the diameter of the threaded shaft.

14. The fastener of claim 13, wherein the diameter of the aperture is less than 10% of the diameter of the threaded shaft.

15. The fastener of claim 14, wherein the diameter of the aperture is less than 5% of the diameter of the threaded shaft.

16. The fastener of claim 15, wherein the aperture has a faceted cross section.

17. The fastener of claim 16, wherein the aperture has a hexagonal cross section.

18. The fastener of claim 12, wherein the grippable structure comprises a recess sized to receive a turning tool and wherein the aperture is positioned at a base of the recess.

19. The fastener of claim 18, wherein the recess defines a slot and wherein the aperture has a width substantially equal that of the slot.

20. The fastener of claim 19, wherein the aperture has a cross section sized to receive at least one of a torx, allen, or triangular wrench.
